(19) United States
(12) Patent Application Publication
(10) Pub. No.: US 2004/0221783 A1
(43) Pub. Date: Nov. 11, 2004

(54) Fabric processing method

(75) Inventor: Akiko Niimi, Nagoya-shi (JP)

Correspondence Address: OLIFF & BERRIDGE, PLC, P.O. BOX 19928, ALEXANDRIA, VA, 22320, US

(73) Assignee: BROTHER KOGYO KABUSHIKI KAISHA, Nagoya-shi (JP)

(21) Appl. No.: 10/785,026

(22) Filed: Feb. 25, 2004

(30) Foreign Application Priority Data
Mar. 4, 2003 (JP) 2003-057559

(51) Int. Cl. D05C 15/00; D05B 97/00; B41J 2/01

(52) U.S. Cl. 112/475.01

(57) ABSTRACT

The product value of fabric can be increased by changing the texture of the surface of the fabric. On the fabric, provided is an embroidered region that is embroidered by means of embroidery threads is provided on the fabric, and the embroidered region is heated while applying pressure in such a manner that it undergoes an irreversible change. Thereby, after returning to room temperature, the fabric has a different texture, in terms of luster, or the like, from that prior to heating.

### BACKGROUND OF THE INVENTION

1. Field of the Invention

The present invention relates to a method for processing fabric.

2. Description of the Related Art

Fabric (unprocessed cloth) used for clothing, decorative items, or the like, may be embroidered in a desired pattern, by means of an embroidering machine or by hand embroidering, using a plurality of embroidery threads of different colors. However, in this case, the colors which can be represented on the fabric are only those possessed by the embroidery thread itself, and hence they are limited to a relatively small number.

Utility Model No. 3052871 (pages 4-8, FIGS. 1-3) discloses technology for performing color processing, by an ink-jet method, of an embroidered region obtained by embroidering a fabric. By means of this technology, since the embroidered region is colored by means of ink, after a fabric has been embroidered, then the colors thereof are not limited to the colors of the embroidery thread itself, and it is possible to apply a variety of coloration changes, such as multi-color patterns, gradations, or the like, to the embroidered region of the fabric.

However, in the technology described in Utility Model No. 3052871 (pages 4-8, FIGS. 1-3), while it is possible to apply a variety of coloration changes to the fabric, it is not possible to alter the texture of the embroidery thread, in terms of its luster, or the like. Furthermore, in general, if it were possible to apply a texture to the embroidery thread which is different from the actual texture of the embroidery thread itself, regardless of whether or not coloration is applied to the embroidery thread, then it would be possible to increase significantly the product value of such fabric.

### SUMMARY OF THE INVENTION

Therefore, it is an object of the present invention to provide a fabric processing method whereby the product value of fabric can be increased by altering the texture of the surface of the fabric.

The fabric processing method according to a first aspect of the present invention comprises: an embroidering step for embroidering fabric by means of an embroidering device, using thermoplastic embroidery thread, on the basis of image data; and a heat treatment step for heating the fabric in such a manner that the texture of the embroidery thread embroidered onto the fabric in the embroidering step after returning to normal temperature is different from that prior to heating.

In the fabric processing method of the first aspect, the thermoplastic resin embroidered onto the fabric in the embroidering step is heated by the heat treatment step and as a result of this, irreversible change is produced in the embroidery threads, wherein, for instance, the respective filaments constituting the embroidery threads mutually fuse together, and/or the shape of the embroidery threads changes, or the like, whereby the texture of the embroidery threads in terms of the luster thereof, or the like, after returning to normal temperature is different from that prior to heating. Consequently, it is possible to obtain a fabric which has a portion having a texture that is different from that of fabric that is simply embroidered using embroidery thread, wherein, for instance, the sense of luster of the embroidery thread is reduced, and hence the product value of the fabric is increased.

In the present invention, reference to “fabric” indicates a sheet-like fiber structure, such as woven textile, unwoven cloth, or the like, and as the raw material for same, it is possible to use a natural fiber, such as cotton or silk, or a synthetic fiber or semi-synthetic fiber, such as polyester, or the like, or a combination of such fibers. Moreover, here reference to “texture” indicates the visual impression created, such as the sense of luster, or three-dimensionality, or the like, possessed by the fabric.

In the fabric processing method according to a second aspect of the invention, the pressure is applied to the fabric while heating, in the heat treatment step.

In the fabric processing method of the second aspect, the thickness of the embroidery threads is reduced by the pressure applied to the embroidery threads during the heat treatment step, and furthermore the shape thereof in planar view is altered, whereby a fabric having a portion having a different texture from that of a fabric which is subjected to heat treatment without applying pressure can be obtained.

The fabric processing method according to a third aspect of the present invention also comprises, between the embroidering step and the heat treatment step, a printing step for printing an image onto a region of the fabric where embroidery has been performed, by ejecting ink onto the fabric by means of an ink-jet printer, on the basis of image data.

In the fabric processing method of the third aspect, since the image depicted by the ink and the image depicted by the embroidery are mutually superimposed, then a fabric can be obtained which displays visual effects, such as a hidden picture, or the like, that cannot be obtained by means of the respective individual images alone. Moreover, since the printing step is carried out between the embroidering step and the heat treatment step, then the ink can be fixed to the fabric during the heat treatment step, and hence there is no need to perform heat treatment for fixing the ink to the fabric, separately from the aforementioned heat treatment step. Moreover, if a printing step is performed, then it is necessary to use a fabric that can be colored by means of ink (dye). Furthermore, if a printing step is performed, then the color of the embroidery thread can be selected regardless of the ink color.

### BRIEF DESCRIPTION OF THE DRAWINGS

FIGS. 1A, 1B, 1C and 1D are illustrative diagrams showing a sequence of steps of a fabric processing method relating to a first embodiment of the present invention;

FIGS. 2A and 2B illustrate changes in the state of an embroidered fabric caused by a heat treatment step in a fabric processing method relating to the first embodiment of the present invention, wherein FIG. 2A shows a schematic plan view of the embroidered region of an embroidered fabric before heat treatment, and a cross-sectional view along line a2-a2 of same; and FIG. 2B shows a schematic plan view of the embroidered region after heat treatment, and a cross-sectional view along line b2-b2 of same;

FIGS. 3A, 3B, 3C, 3D and 3E are illustrative diagrams showing a sequence of steps of a fabric processing method relating to a second embodiment of the present invention;

FIGS. 4A, 4B and 4C illustrate changes in the state of an embroidered fabric caused by a heat treatment step in a fabric processing method relating to the second embodiment of the present invention, wherein FIG. 4A shows a schematic plan view of the embroidered region of an embroidered fabric before printing, and a cross-sectional view along line a4-a4 of same; FIG. 4B shows a schematic plan view of the embroidered region of an embroidered fabric after printing and before heat treatment, and a cross-sectional view along line b4-b4 of same; and FIG. 4C shows a schematic plan view of the embroidered region after heat treatment, and a cross-sectional view along line c4-c4 of same; and

FIGS. 5A and 5B illustrate changes in the state of an embroidered fabric caused by a heat treatment step in a fabric processing method relating to a third embodiment of the present invention, wherein FIG. 5A shows a schematic plan view of the embroidered region of an embroidered fabric before heat treatment, and a cross-sectional view along line a5-a5 of same; and FIG. 5B shows a schematic plan view of the embroidered region of the embroidered region after heat treatment, and a cross-sectional view along line b5-b5 of same.

### DESCRIPTION OF THE PREFERRED EMBODIMENTS

(First Embodiment)

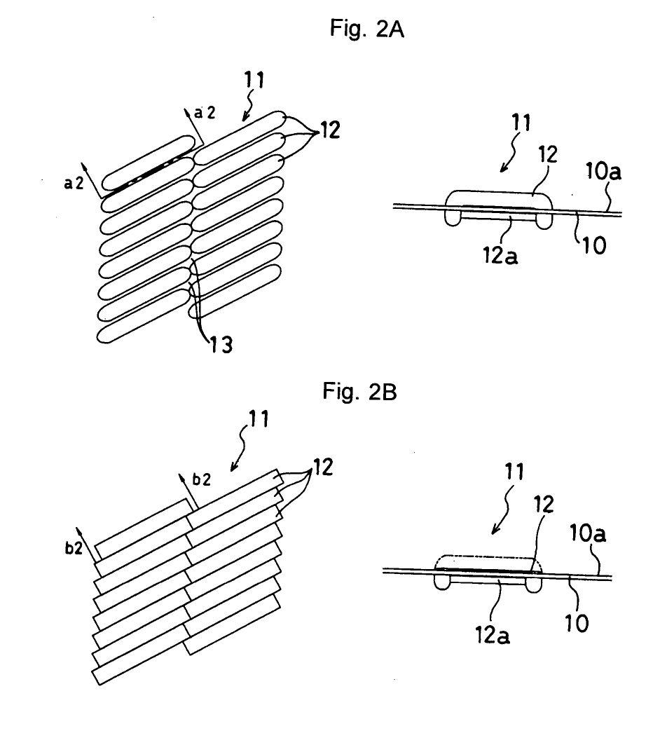

A first embodiment of the present invention is described on the basis of FIGS., and FIGS. 2A and 2B.

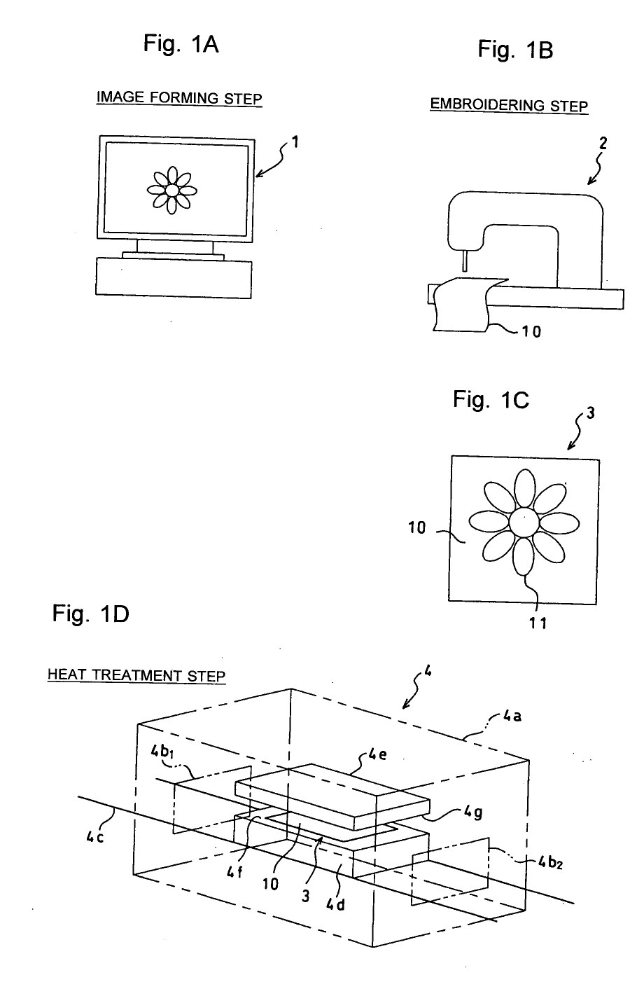

FIGS. 1A, 1B, 1C and 1D are illustrative diagrams showing a sequence of processing steps of a fabric processing method relating to the present embodiment. In the fabric processing method relating to the present embodiment, firstly, as shown in FIG. 1A, image data for embroidering onto the fabric is created on a computer 1 (image data creating step).

In the image data creating step, a paper sheet surface or other object on which a prescribed image is depicted is read in by means of a scanner (not illustrated), and image data relating to embroidery to be performed on a fabric is created by embroidery data creating software in the computer 1, on the basis of the scanned data. Furthermore, in addition to reading in image data into the computer 1 by means of a scanner, it is also possible, for example, to read in image data for an object captured by a digital camera, or image data stored on a magnetic disk or optical disk, or the like, in the computer 1, and create image data for applying to the fabric by embroidery data creating software on the basis of this image data. It is also possible to create image data relating to embroidery to be performed on a fabric, by using embroidery data creating software in the computer 1 alone, without using image data that is read in from a scanner, digital camera, or the like.

Thereupon, as shown in FIG. 1B, embroidering is performed on a fabric 10 made from natural fibers, using a polyester thread as an embroidery thread, by means of an embroidering machine 2, on the basis of the image data created in the image data creating step (embroidering step). The embroidering machine 2 operates on the basis of the image data created by embroidery data creating software in the computer 1.

FIG. 1C shows an embroidered fabric created by means of the embroidering step. In the embroidered fabric 3, an embroidered region 11 which is embroidered with an embroidery thread is formed on the fabric 10. The embroidered region 11 may be embroidered by any kind of sewing techniques or stitches, such as “tatami-nui”, “koma-nui”, “matsuri-nui”, “sashi-nui”, “beta-nui”, “suga-nui”, “sagara-nui”, or the like; where these are Japanese names of embroidery stitches, and approximate explanations of each type of stitch are provided below.

The term “tatami-nui” means a stitch used to fill an area of fabric, creating a dimpled surface similar to that of a Japanese tatami mat, and corresponds to a large version of satin stitch.

The term “koma-nui” means a stitch where one thread (decorative thread) is laid flat over the fabric in a desired pattern, and then held in place by small stitches of a different, thinner thread.

The term “matsuri-nui” means a type of blind stitch generally used on hems and cuffs.

The term “sashi-nui” means a stitch used to fill an area with different layers of threads, which are superimposed on the threads below or inserted between them. A flat, twistless thread is used.

The term “beta-nui” means a stitch used to fill a relatively large area with parallel threads of the same color.

The term “suga-nui” means a stitch where threads are laid parallel to the weft of the base fabric, in a spaced out fashion, creating an effect similar to a bamboo blind.

The term “sagara-nui” means a stitch using knots to create small “balls” of thread on the surface of the fabric, and is similar to “French knots”.

The embroidery thread is white or has a pale color, and is manufactured by drawing together a plurality of filament threads made from polyester having thermoplastic properties, and then twisting them together. Desirably, the thread for the embroidery thread forming the embroidered region 11 of the embroidered fabric 3 is selected appropriately to be one having a lower melting point than the fabric 10, in such a manner that, when subjected to heat treatment, the fabric 10 does not melt before the embroidery thread, or become scorched.

Next, as illustrated in FIG. 1D, the embroidered fabric 3 obtained by means of the embroidering step is pressurized and heated (heat treatment step). In this heat treatment step, the embroidered fabric 3 is heat treated for 30 seconds in a heat treatment device 4, under conditions of 180° C. temperature and 0.4 kg/cm² pressure. The temperature and pressure conditions in the heat treatment step should be such that they provoke an irreversible change in the embroidery thread, in such a manner that the texture of the embroidery thread, in terms of the luster thereof, and the like, after returning to room temperature, is different from its texture before treatment. Therefore, it is not necessarily required to heat the embroidery thread to a temperature equal to or exceeding its melting point, thereby causing it to melt, and provided that the texture of the embroidery thread in terms of its luster, and the like, after returning to room temperature can be changed, then it may be heated to a temperature equal to or below the melting point. More specifically, the temperature conditions should be set in the range of 160° C. to 200° C., the pressure conditions, to a range of 0.2 to 1.0 kg/cm², and the processing time to a range of 10 seconds to 1 minute.

Opening sections 4b1, 4b2 are provided on opposing side walls of the frame 4a of the heat treatment device 4, and a conveyor 4c is provided in such a manner that it passes through the opening sections 4b1, 4b2. A conveyance platform 4d on which the embroidered fabric 3 is mounted is provided on the conveyor 4c. Moreover, a heating and pressurizing member 4e is disposed inside the frame 4a. A heater (not illustrated) is incorporated into the heating and pressurizing member 4e, and by sandwiching the embroidered fabric 3 mounted on the conveyance platform 4d between the conveyance platform 4d and the heating and pressurizing member 4e, the fabric 3 can be heated and pressurized. It is possible to use, for example, a hot press device, an iron, heat press device or the like, as the heat treatment device 4.

The heating and pressurizing member 4e has a rectangular cylindrical shape, and is disposed in a vertically movable fashion in the frame 4a. The lower face 4g of the heating and pressurizing member 4e has a surface area approximately equal to the surface area of the upper face 4f of the conveyance platform 4d, and the temperature thereof is raised by operating the heater inside the heating and pressurizing member 4e. Therefore, by pressing the lower face 4g thereof towards the upper face 4f of the conveyance platform 4d, it is possible to apply heat and pressure to the embroidered region 11 of the embroidered fabric 3, in a uniform manner.

The embroidered fabric 3 mounted on the conveyance platform 4d is conveyed into the frame 4a by the conveyor 4c, by means of the opening section 4b1. When the embroidered fabric 3 has been conveyed to a position opposing the lower face 4g of the heating and pressurizing member 4e, the conveyor 4c transporting the conveyance platform 4d is temporarily halted. Thereupon, the heating and pressurizing member 4e is moved downwards until it reaches a position where the embroidered fabric 3 is sandwiched between the lower face 4g thereof and the upper face 4f of the conveyance platform 4d (the face on which the embroidered fabric 3 is mounted), and the embroidered fabric 3 is pressurized and heated. When the heat treatment has completed, the heating and pressurizing member 4e is raised up to its original position. The embroidered fabric 3 which has been heat treated in this manner is then transported outside via the opening section 4b2, by the conveyor 4c. It is also possible to use a heat treatment device 4 other than that described above, provided that it is capable of simultaneously applying heat and pressure to the surface of the fabric 3.

Here, the change in the state of the embroidered region 11 brought by the fabric processing method according to the present embodiment will be described. FIGS. 2A and 2B illustrate state changes caused by the step for heat treating the embroidered fabric, in the fabric processing method according to the present embodiment; FIG. 2A showing a schematic plan view of an embroidered region of an embroidered fabric before heat treatment, together with a sectional view along line a2-a2 of same; and FIG. 2B showing a schematic plan view of the embroidered region after heat treatment, together with a sectional view along line b2-b2 thereof.

As shown in the left-hand diagram of FIG. 2A, in the embroidered region 11 before heat treatment, the embroidery thread is embroidered in a correct and standard fashion, in such a manner that there is no overlapping between the upper threads 12 on the fabric 10. As shown in the right-hand diagram of FIG. 2A, the under thread 12a is passed in such a manner that it does not obstruct the upper thread 12 passing from above the fabric 10 to below the fabric. In the direction of the thickness of the fabric 10, the upper thread 12 and lower thread 12a assume a projecting state and stand proud from the surface of the fabric 10. Moreover, since the cross-section of the upper thread 12 is approximately circular in shape, either end portion of the upper thread 12 on the upper face 10a of the cloth, when it passes from above the cloth 10 to below the cloth, will have an approximately semi-circular shape. It is not necessary for the upper threads 12 and lower threads 12a, which are embroidery threads, to be made of filaments of the same material. For example, while it is necessary to use thermoplastic material for the upper threads 12, it is possible to use either a thermoplastic material or a non-thermoplastic material for the lower threads 12a.

On the other hand, in the embroidered region 11 after heat treatment, since the upper threads 12 has been heated and pressurized by the heating and pressurizing member 4e, then as illustrated in the right-hand diagram of FIG. 2B, the cross-sectional shape of the upper threads 12 changes from the state prior to heat treatment, as indicated by the dotted line, to the state after heat treatment, as indicated by the solid line. In other words, the thickness of the upper thread 12 is reduced and the amount by which it protrudes from the cloth 10 is reduced. Moreover, by heating the upper threads 12 by means of the heating and pressurizing member 4e, the surface of each of the filaments of the upper threads 12 is caused to melt, the filaments fuse tightly together, and hence the undulations in the surface of the upper threads 12, caused by the twisting thereof, are reduced. As shown in the left-hand diagram of FIG. 2A, since an interval 13 is provided in advance between respective upper threads 12 when the embroidered region 11 is formed, then as the thickness of the upper threads 12 is reduced in the heat treatment step, the upper threads 12 can also spread in the direction orthogonal to the thickness direction (the direction of the surface of the fabric), and the shape of the upper threads 12 in plan view becomes rectangular. Therefore, as shown in the left-hand diagram in FIG. 2B, the intervals 13 become completely filled in.

If the upper threads 12 are arranged together in the embroidering step without leaving intervals, then when they are heated and pressurized in the heat treatment step, it will become difficult to reduce the thickness of the upper threads 12 to the prescribed thickness, and furthermore, due to the spreading of the upper threads 12 in the direction of the surface of the fabric, there is a possibility that the outline of the embroidered region 11 may become corrupted. However, provided that the thickness of the upper threads 12 is not to be reduced significantly, it is possible to provide the embroidered region 11 on the fabric 10 in such a manner that the upper threads 12 are arranged together without intervals therebetween, in the embroidering step.

The change in the embroidery thread from the form illustrated in FIG. 2A to the form illustrated in FIG. 2B is an irreversible change, as described previously, and even when the embroidery thread returns to normal temperature after the heat treatment, it still maintains the form illustrated in FIG. 2B.

In this way, by simultaneously heating and pressurizing the upper threads 12 in the heat treatment step, the upper threads 12 are reduced in thickness and the shape thereof in plan view is changed, whereby a fabric having an embroidered region 11 of a texture that cannot be achieved with conventional embroidery is obtained. For example, if embroidery is formed using white embroidery thread on a white colored cloth, then in the case of conventional embroidery, since the twist and protrusion of the embroidery thread remains the same, light is reflected by the undulations caused by the twist of the embroidery thread, thus causing a sense of the presence of the thread, while at the same time, shadows are created by the protrusion of the embroidery, which means that it will be possible to identify the texture of the embroidery at a single glance, whereas if the thickness of the upper threads 12 in the embroidery thread is reduced and the shape thereof in plan view is changed, while also eliminating undulations in the upper threads 12 due to the twist in the threads, as in the present embodiment, then the protrusion of the embroidered region 11 will be reduced and it will not be liable to create shadow. Consequently, it becomes less easy to tell at a glance that the embroidered region 11 is present, and it will be judged that the fabric is simply a white fabric, but when viewed from a specific angle, the light will be reflected by the whole of the embroidered region 11, causing the presence of the embroidered region 11 to be sensed in a manner whereby it stands out from the fabric, and thus making it possible to obtain a fabric with a texture which has the effect of a hidden picture. In this way, if a fabric is processed in accordance with the present embodiment, then the product value of the fabric 3 is increased.

(Second Embodiment)

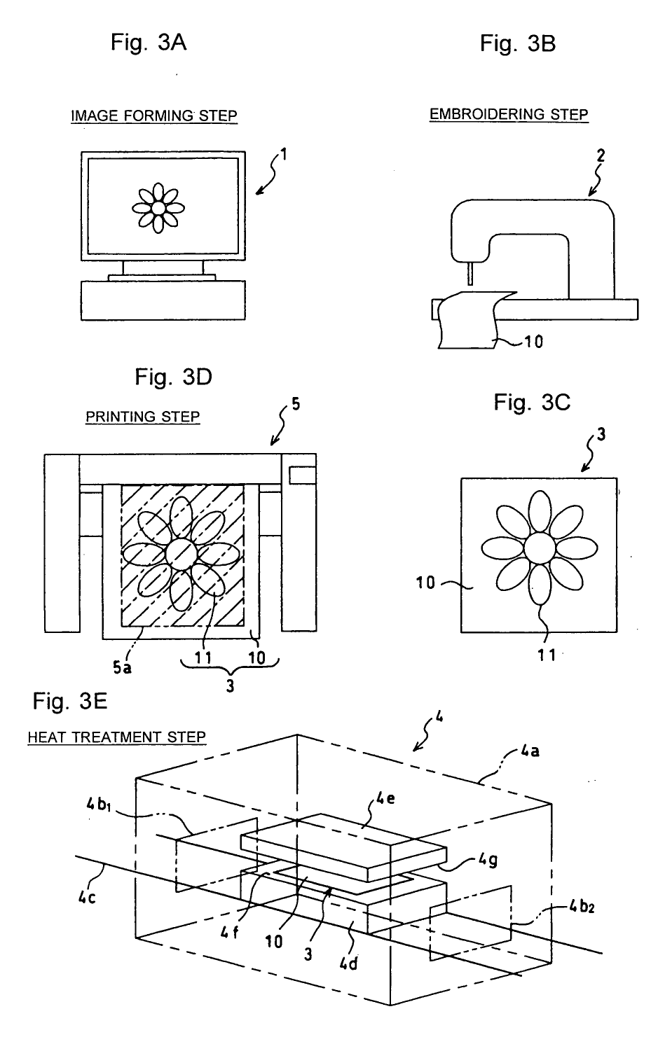

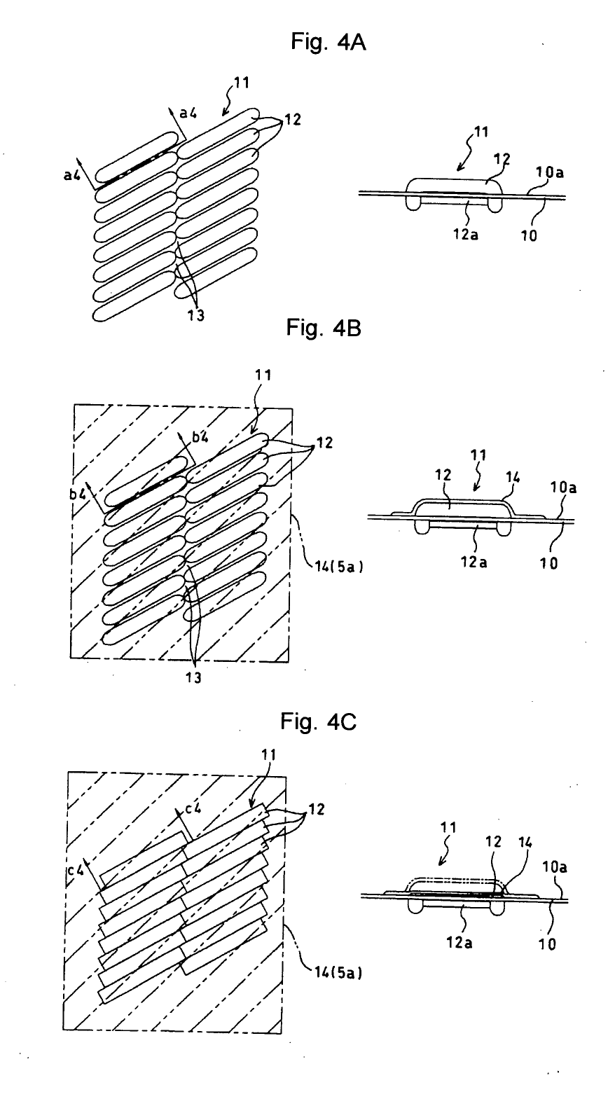

Next, a fabric processing method relating to a second embodiment of the present invention is described below with reference to FIGS. 3A, 3B, 3C, 3D and 3E, and FIGS. 4A, 4B and 4c.

FIGS. 3A, 3B, 3C, 3D and 3E are illustrative diagrams showing a sequence of steps in a fabric processing method relating to the present embodiment. In the fabric processing method relating to the present embodiment, embroidery image data forming image data to be embroidered, and print image data to be printed, are created in the form of separate data, in the image data creating step, and furthermore a printing step is also carried out between the embroidering step and the heat treatment step described in the first embodiment. In other words, the fabric processing method relating to the present embodiment comprises an image data creating step as illustrated in FIG. 3A, an embroidering step as illustrated in FIG. 3B in order to obtain an embroidered fabric 3 such as that depicted in FIG. 3C, a printing step as illustrated in FIG. 3D, and a heat treatment step as illustrated in FIG. 3E. Here, the description centres principally on the printing step and description of the other steps is omitted.

In the printing step illustrated in FIG. 3D, ink is ejected from an ink-jet printer 5 on the basis of the print image data obtained in the image data creating step, thereby printing an image within a print region 5a of the embroidered fabric 3 obtained by means of the embroidering step. For the ink, a water-based ink containing a paste component is used. The print region 5a is set previously in the image data creating step to be the same region as the embroidered region 11 or a region that includes at least a portion of the embroidered region 11.

In the present embodiment, the ink-jet printer 5 uses an ink-jet method of an on-demand type (which emits ink when required), such as a piezoelectric system that emits ink particles by inducing a change in the volume of an ink chamber by varying the electrical signal applied to a piezoelectric element. The ink-jet printer 5 and the computer 1 are connected together by means of a connection cable, or the like, and print signals are supplied to the ink-jet printer 5 from the computer 1, via the connection cable, on the basis of the image data read into the computer 1 or the print image data created thereby.

After performing printing on the embroidered fabric 3 in the printing step, the fabric is heat treated by means of a heat treatment step, similarly to the first embodiment. Thereby, the ink that has adhered to the fabric 3 in the printing step is caused to cure and becomes fixed to the fabric 10.

Here, the change in the state of the embroidered region 11 caused by the fabric processing method according to the present embodiment will be described. FIGS. 4A, 4B and 4C illustrate the changes in the state of an embroidered fabric caused by the heat treatment step of the fabric processing method according to the present embodiment; FIG. 4A showing a schematic plan view of an embroidered region of an embroidered fabric before printing, together with a sectional view along line a4-a4 in same, FIG. 4B showing a schematic plan view of an embroidered region of an embroidered fabric after printing and before heat treatment, together with a sectional view along line b4-b4 in same, and FIG. 4C showing a schematic plan view of the embroidered region after heat treatment, together with a sectional view along line c4-c4 in same.

As shown in the left-hand diagram and the right-hand diagram in FIG. 4A, before printing, upper threads 12 and lower threads 12a are embroidered in the embroidered region 11 in the same state as the left-hand diagram and right-hand diagram in FIG. 2A.

Thereupon, if printing is performed on the embroidered region 11, then as illustrated in the left-hand diagram and right-hand diagram of FIG. 4B, ink 14 emitted from the ink-jet printer 5 adheres to the surface of the upper threads 12 and the fabric 10, within the print region 5a.

If heat treatment is then carried out on the embroidered region 11, since the upper threads 12 are heated and pressed by means of the heating and pressurizing member 4e, then as illustrated by the right-hand diagram in FIG. 4C, the cross-sectional shape of the upper threads 12 will change from the state before heating and pressurization as indicated by the dotted line, to the state after heating and pressurization as indicated by the solid line. In other words, the thickness of the upper threads 12 is reduced, and the protrusion thereof from the fabric 10 is reduced. Moreover, by heating the upper threads 12 by means of the heating and pressurizing member 4e, the ink 14 is cured, the paste component contained in the ink 14 hardens and fixes to the upper threads 12, and furthermore, the surface of the respective filaments of the upper threads 12 melt and become tightly fused together, whereby the undulations in the surface of the upper threads 12 caused by the twist thereof are reduced. As illustrated by the left-hand diagram in FIG. 4A, intervals 13 are provided in advance between respective upper threads 12 when forming the embroidered region 11, and hence as the thickness of the upper threads 12 is reduced by the heat treatment step, the upper threads 12 spread in the direction opposite to the thickness direction (the direction of the surface of the cloth), and the shape of the upper threads 12 in plan view becomes a rectangular shape. Therefore, as illustrated by the left-hand diagram in FIG. 4C, the intervals 13 are filled up completely.

The fabric 3 obtained in this manner will appear readily at a glance as though an image has simply been printed with ink 14 onto the fabric 10, but by reducing the thickness of the upper threads 12 which are covered by the ink 14, light will be reflected from the whole surface of the embroidered region 11 covered by the ink 14 when viewed from a particular angle, and the presence of the embroidered region 11 will be perceived as if it were floating above the fabric 10, thereby yielding a cloth with a texture which has the effect of a hidden picture. In particular, in the present embodiment, by superimposing printing using ink and embroidery using embroidery thread, it is possible to obtain a texture that cannot be achieved by means of the first embodiment.

Furthermore, since it is devised that the printing step is carried out between the embroidering step and the heat treatment step, the ink 14 can be fixed to the fabric 10 and the embroidered region 11 by the heat treatment step, and therefore a merit is obtained in that there is no need to perform a separate heat treatment step for heat treatment in order to fix the ink 14 to the fabric 10. Moreover, it is also possible to obtain a beneficial effect in that the change in the surface of the embroidery thread is accelerated, according to the water content of the ink.

(Third Embodiment)

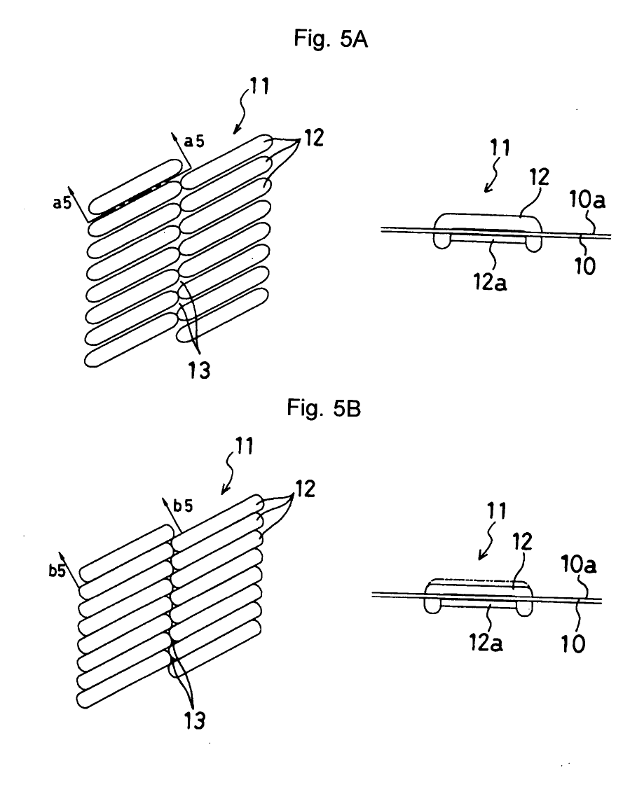

Next, a fabric processing method relating to a third embodiment of the present invention is described below with reference to FIGS. 1A, 1B, 1C and 1D, and FIGS. 5A and 5B.

Similarly to the first embodiment, the fabric processing method relating to the present embodiment comprises an image data creating step as illustrated in FIG. 1A, an embroidering step as illustrated in FIG. 1B for the purpose of obtaining an embroidered fabric 3 such as that depicted in FIG. 1C, and a heat treatment step as illustrated in FIG. 1D, the heat treatment step being performed without applying pressure and corresponding to the heat treatment step in the first embodiment but performed under conditions of no applied pressure. Therefore, description of the image data creating step and the embroidering step is omitted here.

In the present embodiment, the heat treatment step is carried out using the heat treatment device 4 described above. When the embroidered fabric 3 is heat treated, the heating and pressurizing member 4e is not moved downwards. Therefore, after the embroidered fabric 3 mounted on the conveyance platform 4d has been conveyed inside the heat treatment device 4, the embroidered fabric 3 is heated for 30 seconds under conditions of 180° C. temperature and atmospheric pressure, by means of the heater inside the heating and pressurizing member 4e. In other words, the fabric 3 is heated without carrying out pressurization by means of the heating and pressurizing member 4e as described previously.

Here, the change in the state of the embroidered region 11 caused by the fabric processing method of the present embodiment will be described. FIGS. 5A and 5B show the state change in the embroidered fabric caused by the heat treatment step of the fabric processing method according to the present embodiment, FIG. 5A showing a schematic plan view of an embroidered region of an embroidered fabric before heat treatment, together with a sectional view along line a5-a5 thereof, and FIG. 5B showing a schematic plan view of the embroidered region after heat treatment, together with a sectional view along line b5-b5 thereof.

As shown by the left-hand and right-hand diagrams of FIG. 5(a), prior to printing, the upper threads 12 and lower threads 12a are embroidered in the embroidered region 11 in the same manner as the left-hand and right-hand diagrams of FIG. 2A.

When heat treatment is applied to the embroidered region 11, since the upper threads 12 are heated by the heating and pressurizing member 4e, as shown in left-hand diagram of FIG. 5B, the cross-sectional shape of the upper threads 12 changes from the state before heating, as illustrated by the dotted line, to the state after heating as illustrated by the solid line. In other words, the thickness of the upper threads 12 is reduced and the protrusion thereof above the fabric 10 is slightly lessened. Moreover, due to the heating of the upper threads 12 by the heating and pressurizing member 4e, the surface of each filament of the upper threads 12 melts and the respective filaments fuse tightly together, thereby reducing the undulations in the surface of the upper threads 12 caused by the twist thereof. Intervals 13 are provided in advance between respective upper threads 12 when forming the embroidered region 11, as illustrated in the left-hand diagram of FIG. 5A, and therefore as the thickness of the upper threads 12 is reduced by the heat treatment step, the upper threads 12 also spread in the direction orthogonal to the thickness direction (that is, in the direction of the surface of the fabric), and the upper threads 12 assume an approximately rectangular shape when observed in plan view. Therefore, as shown in FIG. 5B, the intervals 13 are filled in almost completely.

By heating the upper threads 12 in this way in the heat treatment step, the thickness of the upper threads 12 is slightly reduced and the shape thereof in plan view is also changed, whereby a fabric 3 having an embroidered region 11 with a texture that cannot be achieved by means of conventional embroidery is obtained. The embroidered region 11 of the fabric 3 obtained by means of the present embodiment differs in texture from the embroidered region 11 of the fabric 3 obtained by means of the first embodiment in accordance with the fact the pressurization is not carried out in the heat treatment step. Consequently, a fabric having a different product value from that of the first embodiment can be obtained.

Preferred embodiments of the present invention were described above, but the present invention is not limited to the respective embodiments described above, and various modifications are also possible within the scope of the claims. For example, in the second embodiment, it is also possible to perform heating without pressurization of the printed embroidered fabric 3, in the heat treatment step. In such a case, a sense of three-dimensionality can be added to the image printed on the embroidered region 11 of the embroidered fabric 3, and hence a fabric having different product value from that of the second embodiment can be obtained.

As described above, according to the present invention, a fabric is obtained which has a portion having a texture that is different from that of fabric that is simply embroidered using embroidery thread, wherein, for instance, the sense of luster of the embroidery thread is reduced, and hence the product value of the fabric is increased.

The entire disclosure of the specification, summary, claims and drawings of Japanese Patent Application No. 2003-57559 filed on Mar. 4, 2003 is hereby incorporated by reference.

What is claimed is:

1. A fabric processing method comprising:
an embroidering step for embroidering fabric by means of an embroidering device, using thermoplastic embroidery thread, on the basis of image data; and
a heat treatment step for heating said fabric in such a manner that the texture of the embroidery thread embroidered onto said fabric in said embroidering step after returning to normal temperature is different from that prior to heating.

2. The fabric processing method according to claim 1, wherein pressure is applied to said fabric while heating, in said heat treatment step.

3. The fabric processing method according to claim 1, wherein said thermoplastic embroidery thread has a lower melting point than the fabric.

4. The fabric processing method according to claim 1, wherein said image data comprises embroidery image data and print image data.

5. The fabric processing method according to claim 1, further comprising an image data creating step for creating said image data on a computer.

6. The fabric processing method according to claim 1, further comprising, between said embroidering step and said heat treatment step, a printing step for printing an image onto a region of said fabric where embroidery has been performed, by ejecting ink onto said fabric by means of an ink-jet printer, on the basis of image data.
